(19) United States
(12) Patent Application Publication
(10) Pub. No.: US 2021/0060498 A1
(43) Pub. Date: Mar. 4, 2021

(54) A THIN FILM COMPOSITE MEMBRANE

(71) Applicant: National University of Singapore, Singapore (SG)

(72) Inventors: Wenxiao Gai, Singapore (SG); Dieling Zhao, Singapore (SG); Tai-Shung Neal Chung, Singapore (SG)

(21) Appl. No.: 16/958,800

(22) PCT Filed: Jan. 3, 2019
(86) PCT No.: PCT/SG2019/050002

§ 371 Date: Jun. 29, 2020

(30) Foreign Application Priority Data
Jan. 3, 2018 (SG) 10201800058U

(51) Int. Cl. B01D 69/14; B01D 69/12; B01D 71/02; B01D 71/56; B01D 69/02; B01D 69/08; B01D 61/00; B01D 71/68

(52) U.S. Cl. CPC B01D 69/148; B01D 69/125; B01D 71/021; B01D 71/56; B01D 69/02; C01B 32/15; B01D 61/002; B01D 71/68; B01D 2323/40; B01D 2325/24; B01D 69/08

(57) ABSTRACT

There is provided a thin film composite (TFC) membrane comprising a support layer and a selective layer, formed of a cross-linked polyamide comprising Na⁺-functionalised carbon quantum dots (NaCQD), on a surface of the support layer. There is also provided a method of forming the TFC membrane.

### TECHNICAL FIELD

The present invention relates to a thin film composite membrane and a method of forming the same.

### BACKGROUND

Osmotic energy is increasingly acknowledged as one of the promising renewable and sustainable energy sources. Pressure retarded osmosis (PRO) is one of the main techniques that aims to harvest the osmotic energy from two solutions with different salinities. PRO employs semi-permeable membranes between these two solutions. Since water spontaneously diffuses across the semi-permeable membranes from the low concentration side (i.e. feed solution) to the pressurised high concentration side (i.e. draw solution) due to the chemical potential difference, it results in a higher pressure or higher volume in the draw solution compartment. It is therefore possible to convert the hydrostatic potential via hydro-turbines or pressure exchangers for power generation. Integration between PRO and seawater reverse osmosis (SWRO) desalination as well as membrane distillation has been proposed. However, the performance of such an integrated system would depend on, among other factors, the performance of the PRO membrane.

An example of a suitable PRO membrane is a thin film composite (TFC) membrane made from interfacial polymerization. Much research has been conducted on improving the mechanical strength of the membrane, as well as to improve the water permeability of the TFC membrane by appropriate modifications of the polyamide selective layers such as using additives or surfactants in the monomer solution and post-treating the nascent polyamide selective layer with chloride, alkaline, alcohol, etc. However, many additives considered have a relatively large size compared with the thickness of the selective layer and therefore it is difficult to fabricate a defect-free selective layer consisting of uniformly dispersed additives. In particular, TFC membranes incorporated with large-sized additives tend to have non-selective voids formed between the additives and the polymer matrices.

There is therefore still a need for an improved TFC membrane and an improved method of forming the TFC membrane which is low-cost, environmentally friendly and easily scalable.

### SUMMARY OF THE INVENTION

The present invention seeks to address these problems, and/or to provide an improved thin film composite (TFC) membrane.

In general terms, the invention relates to a TFC membrane which has improved peak power density and water flux as a result of improved structural properties of the selective layer of the TFC membrane.

According to a first aspect, the present invention provides a thin film composite (TFC) membrane comprising:
a support layer; and
a selective layer on a surface of the support layer, the selective layer formed of a cross-linked polyamide comprising Na⁺-functionalised carbon quantum dots (NaCQD).

According to a particular aspect, the TFC membrane may be a TFC hollow fibre membrane. Accordingly, the support layer may be a porous hollow fibre support layer. The selective layer may be on an inner circumferential surface of the hollow fibre support layer.

According to a particular aspect, the support layer may be formed of a polymer or a ceramic material. For example, the polymer may comprise, but is not limited to, polyethersulfone, polysulfone, polyphenylsulfone, polyacrylonitrile, polyimide, polyether imide, polyamide-imide, polyvinylidene fluoride, cellulose acetate, cellulose triacetate, polyetherketone, polyetheretherketone, or a combination thereof. In particular, the support layer may be formed of polyethersulfone.

The support layer may have a suitable thickness. For example, the support layer may have a thickness of 100-500 μm.

The selective layer may have a suitable thickness. For example, the selective layer may have a thickness of 50-500 nm.

The TFC membrane may have suitable properties. For example, the TFC membrane may have a pure water permeability rate of 1.5-6.0 L m⁻² h⁻¹ bar⁻¹. The TFC membrane may have a burst pressure of at least 15-35 bar. The TFC membrane may have a power density of 15-40 W/m². The TFC membrane may have a salt rejection rate of 97%.

The TFC membrane may be used for any suitable application. In particular, the TFC membrane may be for use in pressure retarded osmosis (PRO), osmotic power generation, or reverse osmosis desalination.

According to a second aspect, the present invention provides a method of forming the TFC membrane according to the first aspect, the method comprising:
providing a support layer; and
forming a selective layer on a surface of the support layer through interfacial polymerization, wherein the forming comprises contacting the surface of the support layer with a first solution comprising a polyamine and Na⁺-functionalised carbon quantum dots (NaCQD), removing excess of the first solution by purging air and subsequently contacting the surface of the support layer with a second solution comprising a polyfunctional acyl halide.

In particular, the support layer may be as described above in relation to the first aspect.

According to a particular aspect, the support layer may be a porous hollow fibre support layer and the selective layer may be on an inner circumferential surface of the hollow fibre support layer. Accordingly, the method may be a method of forming a TFC hollow fibre membrane. The method may comprise:
preparing a module comprising at least one porous hollow fibre support layer potted in the module; and
forming the selective layer on an inner circumferential surface of the hollow fibre support layer through interfacial polymerization, wherein the forming may be as described above.

According to a particular aspect, the porous hollow fibre support layer may be prepared by:
providing a dope solution comprising a polymer solution or a ceramic solution, a solvent/non-solvent mixture and water to an annulus of a spinneret;
providing a bore solution to an inner tube of the spinneret; and
extruding the dope solution and bore solution through the spinneret into a coagulation bath, thereby obtaining a porous hollow fibre support layer.

The dope solution may comprise a suitable polymer solution. For example, the polymer comprised in the polymer solution may comprise, but is not limited to, polyethersulfone, polysulfone, polyphenylsulfone, polyacrylonitrile, polyimide, polyether imide, polyamide-imide, polyvinylidene fluoride, cellulose acetate, cellulose triacetate, polyetherketone, polyetheretherketone or a combination thereof. In particular, the polymer solution may comprise polyethersulfone.

The first solution may comprise any suitable polyamine. For example, the polyamine may be, but is not limited to, m-phenylenediamine (MPD), p-phenylenediamine, p-xylylenediamine, cyclohexanediamine, piperazine, branched or dendrimeric polyethylenimine, or a combination thereof.

According to a particular aspect, the first solution may further comprise a surfactant. The surfactant may be any suitable surfactant. For example, the surfactant may be, but not limited to, sodium dodecyl sulphate (SDS), trimethylamine (TEA), camphorsulfonic acid (CSA), or a combination thereof.

The first solution may comprise a suitable amount of NaCQD. According to a particular aspect, the first solution may comprise 0.5-2 weight % NaCQD.

The second solution may comprise any suitable polyfunctional acyl halide. For example, the polyfunctional acyl halide may be, but not limited to, trimesoyl chloride (TMC), isophthaloyl chloride, terephthaloyl chloride, 1,3,5-cyclohexane tricarbonyl chloride, 1,2,3,4-cyclohexane tetracarbonyl chloride, or a combination thereof.

According to a particular aspect, the second solution may further comprise an organic solvent. The organic solvent may be any suitable organic solvent. For example, the organic solvent may be, but not limited to, hexane, heptane, cyclohexane, isoparaffinic hydrocarbon, or a combination thereof.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of the syntheses of the CQDs and NaCQDs;

FIG. 2 shows the transmission electron microscopy (TEM) images of the CQDs and NaCQDs;

FIG. 3 shows Fourier-transform infrared spectroscopy (FT-IR) of CQD and NaCQD;

FIGS. 4(a1) and (b1) show the field emission scanning electron microscope (FESEM) images of the cross-section and inner surface polyamide layers, respectively, of the conventional TFC membrane, FIGS. 4(a2) and (b2) show the FESEM images of the cross-section and surface polyamide layers, respectively, of the TFC membrane incorporating CQD, FIGS. 4(a3) and (b3) show the FESEM images of the cross-section and surface polyamide layers, respectively, of the TFC membrane incorporating 1.0 wt % Na-CQD-5, and FIGS. 4(a4) and (b4) show the FESEM images of the cross-section and surface polyamide layers, respectively, of the TFC membrane incorporating 1.0 wt % Na-CQD-9;

FIG. 5(a) shows the water flux, FIG. 5(b) shows the reverse salt flux and FIG. 5(c) shows the power density of a conventional TFC membrane and TFC membranes according to embodiments of the present invention;

FIGS. 6(a1) and (b1) show the FESEM images of the cross-section and surface polyamide layers, respectively, of the conventional TFC membrane, FIGS. 6(a2) and (b2) show the FESEM images of the cross-section and surface polyamide layers, respectively, of the TFC membrane incorporating 0.5 wt % Na-CQD-9, FIGS. 6(a3) and (b3) show the FESEM images of the cross-section and surface polyamide layers, respectively, of the TFC membrane incorporating 1.0 wt % Na-CQD-9, and FIGS. 6(a4) and (b4) show the FESEM images of the cross-section and surface polyamide layers, respectively, of the TFC membrane incorporating 2.0 wt % Na-CQD-9;

FIG. 7(a) shows the water flux, FIG. 7(b) shows the reverse salt flux and FIG. 7(c) shows the power density of a conventional TFC membrane and TFC membranes according to embodiments of the present invention;

FIG. 8(a) shows the pure water permeability, FIG. 8(b) shows the salt permeability, and FIG. 8(c) shows the salt rejection, of the TFC membrane according to one embodiment of the present invention in comparison with a conventional TFC membrane;

FIG. 9 shows the TEM images of the CQDs and NaCQDs;

FIG. 10 shows the FT-IR spectra of CQDs and NaCQDs;

FIGS. 11(a1) and (b1) show the FESEM images of the cross-section and inner surface polyamide layers, respectively, of the conventional TFC membrane, FIGS. 11 (a2) and (b2) show the FESEM images of the cross-section and inner surface polyamide layers, respectively, of the TFC membrane incorporating CQDs and FIGS. 11 (a3) and (b3) show the FESEM images of the cross-section and inner surface polyamide layers, respectively, of the TFC membrane incorporating NaCQDs;

FIG. 12(a) shows the pure water permeability and FIG. 12 (b) shows the salt permeability, of the conventional TFC membrane and TFC membrane according to one embodiment of the present invention; and

FIG. 13(a) shows the pure water permeability and FIG. 13 (b) shows the salt permeability, of the conventional TFC membrane and TFC membrane according to one embodiment of the present invention.

### DETAILED DESCRIPTION

As explained above, there is a need for an improved TFC membrane which is able to sustain high operating pressures, having superior transport properties while achieving a high power density.

In general terms, the present invention provides a thin film composite (TFC) membrane incorporating carbon quantum dots, particularly Na⁺-functionalised carbon quantum dots, which can sustain high operating pressures and provide high power density as compared to conventional TFC membranes without carbon quantum dots, thereby making the membrane useful for osmotic power generation without compromising on the water permeability and salt rejection. The membrane of the present invention may also be used in several applications including, but not limited to, pressure retarded osmosis, reverse osmosis, brackish water reverse osmosis desalination, nanofiltration, and forward osmosis. In particular, the osmotic energy produced as a result of using the membrane of the present invention may be comparable to other renewable energies.

The present invention also provides an improved method of forming the TFC membrane, which results in a TFC membrane having improved mechanical and transport properties so that it would produce higher osmotic energy. In particular, the Na⁺-functionalised carbon quantum dots (NaCQD) are incorporated into the polyamide selective layer via the conventional interfacial polymerization reaction.

According to a first aspect, the present invention provides a thin film composite (TFC) membrane comprising:
a support layer; and
a selective layer on a surface of the support layer, the selective layer formed of a cross-linked polyamide comprising Na⁺-functionalised carbon quantum dots (NaCQD).

The TFC membrane may be any suitable TFC membrane. For example, the TFC membrane may be, but not limited to, a TFC hollow fibre membrane, an inner selective TFC membrane, an outer selective TFC membrane, or a flat sheet membrane.

According to a particular aspect, the TFC membrane may be a TFC hollow fibre membrane. In particular, the TFC membrane may be an inner-selective TFC hollow fibre membrane. When the TFC membrane is a TFC hollow fibre membrane, the support layer may be a porous hollow fibre support layer. When the TFC membrane is an inner-selective TFC hollow fibre membrane, the support layer may be a porous hollow fibre support layer and the selective layer may be on an inner circumferential surface of the hollow fibre support layer.

The support layer may be formed of any suitable material. For example, the support layer may be formed of a polymeric material or a ceramic material.

According to a particular aspect, the support layer may be formed of a polymeric material. The polymeric material may comprise any suitable polymer. For example, the polymer may be, but not limited to, polyethersulfone, polysulfone, polyphenylsulfone, polyacrylonitrile, polyimide, polyether imide, polyamide-imide, polyvinylidene fluoride, cellulose acetate, cellulose triacetate, polyetherketone, polyetheretherketone, or a combination thereof. In particular, the support layer may be formed of polyethersulfone (PES).

The support layer may be of a suitable thickness. For example, the thickness of the support layer may be 100-500 μm. For example, the thickness of the hollow fibre support layer may be 150-450 μm, 175-425 μm, 200-400 μm, 250-375 275-350 μm, 300-325 μm. In particular, the thickness may be 200-300 μm.

The selective layer may be of a suitable thickness. The selective layer of the TFC membrane may be thinner as compared to a conventional TFC membrane without NaCQD. For example, the thickness of the selective layer may be 50-500 nm, 100-480 nm, 120-450 nm, 150-400 nm, 175-375 nm, 200-350 nm, 250-325 nm, 275-300 nm. In particular, the thickness may be about 200-350 nm. Even more particular, the thickness may be about 300-350 nm.

The TFC membrane achieves a favourable power density, making it a suitable candidate for use in power generation. The power density may vary depending on the pressure applied during the osmosis process. In particular, the peak power density of the TFC membrane may be 15-40 W/m². For example, the power density achieved may be 18-38 W/m², 20-35 W/m², 22-34 W/m², 25-33 W/m², 27-32 W/m², 28-30 W/m². In particular, the power density achieved may be about 34.2 W/m² at 23 bar using a 1.0 M NaCl solution and deionised (DI) water as the draw and feed solutions, respectively.

According to a particular aspect, the TFC membrane has a suitably high burst pressure. For the purposes of the present invention, the burst pressure may be defined as the highest pressure sustained by the membrane before structural failure. The burst pressure of the membrane of the present invention may be at least 20 bar. In particular, the burst pressure may be 15-35 bar, 20-30 bar, 22-28 bar, 23-27 bar, 24-25 bar. Even more in particular, the burst pressure may be about 25 bar. Higher burst pressures make the membrane more suitable for use in desalination, particularly when a hypersaline draw solution is used in PRO. In particular, with higher burst pressures compared to other inner-selective TFC hollow fibre membranes, the membrane of the present invention may be more suitable for use in PRO when seawater brine is used as the draw solution.

In addition to having a higher burst pressure, the membrane according to the first aspect also has a suitably high pure water permeability rate, low salt permeability rate and high salt rejection rate. The calculations of the water permeability rate, salt permeability rate and salt rejection rate are described in detail with specific reference to a particular TFC hollow fibre membrane in the Example section. However, it would be understood by a person skilled in the art that the calculations may apply to other TFC membranes within the scope of the present invention, and not necessarily restricted to the specific support layer and selective layer described in the Example.

According to a particular aspect, the TFC membrane may have a high pure water permeability rate of 1.5-6.0 L m⁻² h⁻¹ bar⁻¹. In particular, the pure water permeability rate may be 2.5-4.5 L m⁻² h⁻¹ bar⁻¹. Even more in particular, the pure water permeability rate may be about 4.27 L m⁻² h⁻¹ bar⁻¹.

In particular, the TFC membrane may have a low salt permeability rate of 0.4-1.0 L m⁻² h⁻¹ bar⁻¹. Even more in particular, the salt permeability rate may be about 0.53-0.86 L m⁻² h⁻¹ bar⁻¹.

In particular, the TFC membrane may have a favourably high salt rejection rate of ≥97%. Even more in particular, the salt rejection rate may be 97-99%.

The TFC membrane of the present invention may also have a suitable high water flux. According to a particular aspect, the water flux may be 55-58 LMH at 15 bar. Even more in particular, the TFC hollow fibre membrane may have a water flux of about 57.65±3.26 LMH at 15 bar.

The TFC membrane may be used for any suitable applications as described above. In particular, the TFC membrane may be for use in, but not limited to, pressure retarded osmosis (PRO), osmotic power generation, or reverse osmosis desalination. Even more in particular, the membrane may be used in PRO applications, particularly for osmotic power generation and desalination.

According to a second aspect, the present invention provides a method of forming the TFC membrane according to the first aspect, the method comprising:
providing a support layer; and
forming a selective layer on a surface of the support layer through interfacial polymerization, wherein the forming comprises contacting the surface of the support layer with a first solution comprising a polyamine and Na⁺-functionalised carbon quantum dots (NaCQD), removing excess of the first solution by applying air and subsequently contacting the surface of the support layer with a second solution comprising a polyfunctional acyl halide.

The support layer may be as described above. In particular, the support layer may be a polymeric support layer.

The first solution may comprise any suitable polyamine. For example, the polyamine may be, but not limited to, m-phenylenediamine (MPD), p-phenylenediamine, p-xylylenediamine, cyclohexanediamine, piperazine, branched or dendrimeric polyethylenimine, or a combination thereof. In particular, the polyamine may be MPD.

The Na⁺-functionalised carbon quantum dots (NaCQD) comprised in the first solution may be of a suitable size. For example, the size of the NaCQD may be ≤20 nm, particularly ≤10 nm.

The first solution may comprise a suitable amount of NaCQD. According to a particular aspect, the first solution may comprise 0.5-2 weight % NaCQD based on the total weight of the first solution. In particular, the first solution may comprise 0.5 weight %, 1.0 weight %, 1.5 weight % or 2 weight % NaCQD. Even more in particular, the first solution may comprise 1.0 weight % NaCQD.

The NaCQD may be formed by any suitable method. For example, the NaCQD may be formed from quantum carbon dots (QCD). The QCD may be neutralised with NaOH solution to a suitable pH to form NaCQD. In particular, the QCD may be neutralised with NaOH to pH 5-10. Even more in particular, the QCD may be neutralised to a pH of about 5 or 9.

According to a particular aspect, the first solution may further comprise a surfactant. The surfactant may be any suitable surfactant. For example, the surfactant may be, but not limited to, sodium dodecyl sulphate (SDS), trimethylamine (TEA), camphorsulfonic acid (CSA), or a combination thereof. In particular, the surfactant may be SDS.

According to a particular embodiment, the first solution may comprise MPD, NaCQD and SDS. The first solution may comprise a suitable amount of MPD, NaCQD and SDS. For example, the first solution may comprise 1-4 wt % MPD, 0.5-2 wt % NaCQD and 0-2 wt % SDS. In particular, the first solution may comprise a 2 wt % MPD aqueous solution, 1 wt % NaCQD and 0.1 wt % SDS solution. Even more in particular, the first solution may comprise 2 wt % MPD aqueous solution, 1 wt % NaCQD neutralised at pH 9 and 0.1 wt % SDS solution.

The contacting with the first solution comprises introducing the first solution to a surface of the porous hollow fibre support layer for a pre-determined period of time. The removing excess of the first solution may then be carried out by applying air, such as purging air.

The second solution may comprise any suitable polyfunctional acyl halide. For example, the polyfunctional acyl halide may be, but not limited to, trimesoyl chloride (TMC), isophthaloyl chloride, terephthaloyl chloride, 1,3,5-cyclohexane tricarbonyl chloride, 1,2,3,4-cyclohexane tetracarbonyl chloride, or a combination thereof. In particular, the polyfunctional acyl halide may be TMC.

According to a particular aspect, the second solution may further comprise an organic solvent. The organic solvent may be any suitable organic solvent. For example, the organic solvent may be, but not limited to, hexane, heptane, cyclohexane, isoparaffinic hydrocarbon, or a combination thereof. In particular, the organic solvent may be hexane.

According to a particular embodiment, the second solution may comprise TMC and hexane. In particular, the second solution may comprise 0.05-0.3 wt % TMC in hexane. Even more in particular, the second solution may comprise 0.15 wt % TMC in hexane.

The contacting with the second solution may comprise introducing the second solution to the surface of the support layer saturated with the first solution for a pre-determined period of time to form the selective layer on the support layer.

The method may further comprise draining off the second solution, stabilising the selective layer formed and/or rinsing the thin film composite membrane formed. The draining off of the second solution may be by any suitable means. For example, the draining off of the second solution may be by purging air.

According to a particular aspect, the TFC membrane formed may be a TFC hollow fibre membrane. When the TFC membrane formed is a TFC hollow fibre membrane, the support layer may be a porous hollow fibre support layer.

According to a particular aspect, the TFC membrane formed may be an inner selective TFC hollow fibre membrane. Accordingly, the support layer may be a porous hollow fibre support layer and the selective layer may be formed on an inner circumferential surface of the hollow fibre support layer. The method of forming the TFC hollow fibre membrane may comprise:
preparing a module comprising at least one porous hollow fibre support layer potted in the module; and
forming a selective layer on an inner circumferential surface of the hollow fibre support layer through interfacial polymerization, wherein the forming comprises contacting the surface of the porous hollow fibre support layer with a first solution comprising a polyamine and NaCQD, removing excess of the first solution by applying air and subsequently contacting the surface of the porous hollow fibre support layer with a second solution comprising a polyfunctional acyl halide.

The method may further comprise first preparing the at least one porous hollow fibre support layer. According to a particular aspect, the porous hollow fibre support layer may be prepared by:
providing a dope solution comprising a polymer solution or a ceramic solution, a solvent/non-solvent mixture and water to an annulus of a spinneret;
providing a bore solution to an inner tube of the spinneret; and
extruding the dope solution and bore solution through the spinneret into a coagulation bath, thereby obtaining a porous hollow fibre support layer.

The polymer solution comprised in the dope solution may comprise any suitable polymer. For example, the polymer comprised in the polymer solution may be, but not limited to: polyethersulfone (PES), polysulfone, polyphenylsulfone, polyacrylonitrile, polyimide, polyether imide, polyamide-imide, polyvinylidene fluoride, cellulose acetate, cellulose triacetate, polyetherketone, polyetheretherketone or a combination thereof. In particular, the polymer comprised in the polymer solution may be PES.

According to a particular aspect, the porous hollow fibre support layer may be formed of PES.

In particular, the dope solution may comprise the polymer in N-methyl-2-pyrrolidone (NMP), polyethylene glycol (PEG) and water. NMP may act as a solvent for the polymer. PEG may be employed as a weak non-solvent additive to improve pore connectivity and to enhance pore formation. Water may be added in relatively small amounts to increase dope viscosity and lead the polymer solution close to a bimodal decomposition, resulting in sponge-like porous structure.

Even more in particular, the dope solution comprises PES, NMP, PEG 400 and water. For example, the dope solution may comprise PES, NMP, PEG 400 and water in the following composition: 20-25/30-40/30-40/1-5 wt % based on the total weight of the dope solution.

The bore solution may be any suitable bore solution for the purposes of the present invention. For example, the bore solution may be, but not limited to, tap water, deionised (DI) water, NMP, or a combination thereof. In particular, the bore solution may be DI water.

The coagulation bath may comprise any suitable coagulant. For example, the coagulation bath may comprise water, NMP or a combination thereof. In particular, the coagulation bath may be water.

The TFC membrane of the present invention and formed from the method of the present invention may exhibit enhanced water permeability as compared to conventional TFC membranes without losing salt rejection. Carbon quantum dots are a new class of carbon nanomaterials with advantages of excellent hydrophilicity, low toxicity, environmental friendliness, easy synthesis and low cost. The addition of the NaCQD into the selective layer of the TFC membrane decreases the thickness of the selective layer, increases the surface area of the selective layer as a result of increased crosslinking degree, forms a looser polyamide network due to the interference of the crosslinking between the two monomers in the presence of the NaCQDs, and increases membrane hydrophilicity due to the increased oxygen-containing groups comprised in the selective layer.

As a result of the changes in the characteristics of the TFC membrane comprising the NaCQDs, many advantages are brought about. For example, the decrease in the thickness of the selective layer brings about a decrease in the water transport resistance, while the increased surface area of the selective layer as a result of the increased crosslinking degree results in an increased effective membrane area for separation. The looser polyamide network results in decreased transport resistance and increased water pathways, thereby favourably influencing the water flux. Further, the increased oxygen-containing groups and hydrophilicity favours higher water permeability and results in a lower tendency for fouling.

Having now generally described the invention, the same will be more readily understood through reference to the following embodiment which is provided by way of illustration, and is not intended to be limiting.

### EXAMPLES

### Example 1

### Chemicals and Materials

Veradel® 3100P polyethersulfone (PES, Solvay Specialty Polymers), N-methyl-2-pyrrolidone (NMP, 99.5%, Merck), polyethylene glycol 400 (PEG, Mw=400 g/mol, Acros Organics) and glycerol (Industrial grade, Aik Moh Pains & Chemicals Pte. Ltd.) were purchased to fabricate and post-treat PES hollow fibre support layers for the TFC membranes. 1,3,5-benzenetricarbonyl trichloride (TMC, 98%, Sigma-Aldrich), hexane (99.9%, Fisher Chemicals), m-Phenylenediamine (MPD, 98%, T.C.I.) and sodium dodecyl sulfate (SDS, 99%, Sigma-Aldrich) were employed in the interfacial polymerization process to fabricate the polyamide selective layers of the TFC membranes. Citric acid (99.5%, Sigma-Aldrich) and sodium hydroxide (98%, Sigma-Aldrich) were utilized to synthesize and functionalize the CQDs. Sodium chloride (NaCl, 99.5%, Merck) was acquired to prepare all the saline solutions in this work. The deionized (DI) water used in this work was produced by a Milli-Q ultrapure water system (Millipore, USA). All chemicals were used as received without further purification.

### Syntheses and Characterisation of Carbon Quantum Dots (CQDs)

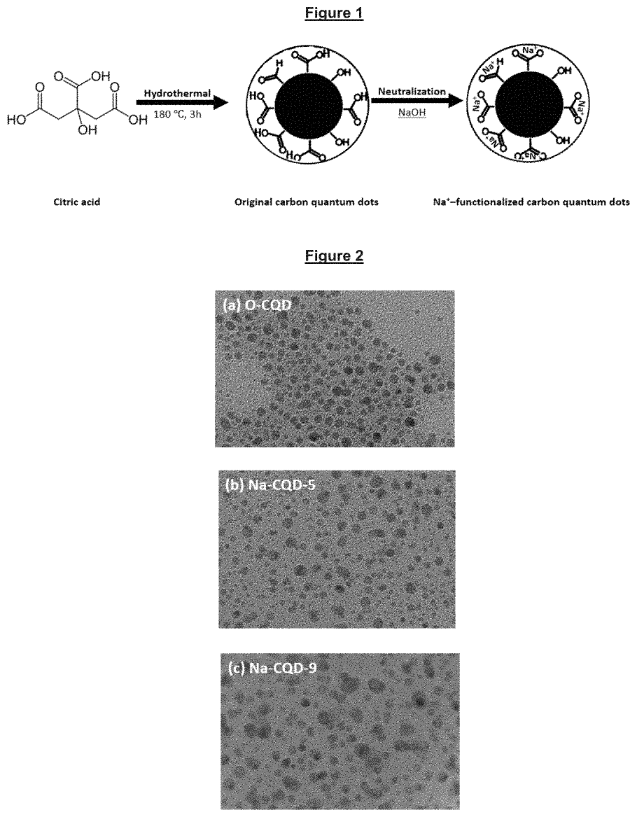

The original CQDs (O-CQD) and Na⁺-functionalised CQDs (NaCQD) were synthesised as illustrated in FIG. 1. Firstly, grinded citric acid powders were put into a glass container covered with a glass slide and then heated in air at 180° C. for 3 hours to form O-CQD passivated with carboxyl groups. Subsequently, the product containing O-CQD was dispersed in DI water, and then dialysed with Slide-A-Lyzer G2 Dialysis Cassettes (2K MWCO) until there was no significant variation of conductivity in the surrounding DI water. After the dialysis process, a portion of the resultant O-CQD aqueous solution was freeze dried directly to get the O-CQD product, while the other portion was neutralized with a NaOH solution of 5.0 M to pH=5 and 9. During the neutralization process, the carboxylic acid groups of O-CQD reacted with hydroxyl groups to form neutralized NaCQD. Afterwards, the NaCQD aqueous solution was also freeze dried to produce two NaCQD products, which are referred to as Na-CQD-5 and Na-CQD-9 for respective CQDs solutions of pH=5 and 9.

The synthesized O-CQD, Na-CQD-5 and Na-CQD-9 were characterized by high-resolution transmission electron microscopy (HR-TEM, JEOL JEM-2100F), Fourier transform infrared spectroscopy (FT-IR, Vertex 70, Bruker, USA) with a wavenumber range of 4000-500 cm⁻¹ and an X-ray photoelectron spectrometer (XPS, Kratos AXIS Ultra^{DLD} spectrometer, Kratos Analytical Ltd) with a mono Al K_{α} X-ray source.

### Fabrication of PES Hollow Fibre Support Layer (Substrate)

The commercial PES polymer, which had been dried at 60° C. under vacuum overnight, was dissolved in a mixture of NMP and PEG (NMP/PEG=1:1) by stirring at 60° C. first, and then DI water was added dropwise into the polymer solution after it was cooled down to room temperature. Subsequently, the polymer solution was stirred slowly for about 24 hours, then the prepared homogenous polymer solution (polymer concentration=21 wt %) was further degassed under vacuum before spinning.

A dry-jet wet spinning process utilising the co-extrusion technique through a dual layer spinneret was employed to prepare the PES hollow fibre support layer as the substrates for the TFC membranes. DI water, polymer solution and NMP were pumped into the dual layer spinneret through the inner, middle and outer channels, respectively, to fabricate the inner-selective hollow fibre substrate. After going through an air gap length of 5 cm, the initial-state fibres entered the water coagulant bath. Finally, the as-spun hollow fibres were collected by a take-up drum. The as-spun PES hollow fibre substrates were immersed in tap water for 2 days before being post-treated by a 50% glycerol aqueous solution for another 2 days followed by air drying for 2 days. Finally, small lab-scale modules were made and each module consisted of three PES hollow fibre substrates.

### Fabrication of TFC-PES Hollow Fibre Membranes

The polyamide selective layer was synthesised on the inner surface of the PES hollow fibre substrates by interfacial polymerization. First, a 2 wt % MPD aqueous solution containing (1) 0.1 wt % SDS and (2) one of the synthesized O-CQD, Na-CQD-5 and Na-CQD-9 at 0-2 wt % was pumped into the lumen side of the lab-scale module for 3 minutes at a flow rate of 4.25 ml/min. Then compressed air was purged into the lumen side of the module for 5 minutes to remove the excessive MPD solution. Subsequently, a 0.15 wt % TMC in hexane solution was pumped into the lumen side of the module at a flow rate of 2.50 ml/min for 5 minutes to react with the MPD solution saturated on the membrane surface. To remove the excess TMC solution, the module was purged with air again through the lumen side for 1 minute. All prepared lab-scale modules were kept in air overnight and then soaked in DI water for at least one day before tests or characterizations. The TFC membranes inside the modules were denoted as TFC-0 (control), TFC-(O-CQD)-1, TFC-(Na-CQD-5)-1, TFC-(Na-CQD-9)-0.5, TFC-(Na-CQD-9)-1 and TFC-(Na-CQD-9)-2, respectively, where 0.5, 1 and 2 refer to the weight percentages of CQDs in the MPD solutions.

### Characterizations of the TFC Hollow Fibre Membranes

To study the effects of CQDs on the polyamide selective layer, various characterisation techniques were employed. To prepare the samples for characterisations, the as prepared lab-scale modules were opened, the TFC membranes were taken out and then soaked in DI water for at least one day to remove any existing glycerol, loosely attached CQDs, unreacted monomers and any other contaminants before being freeze dried.

Field emission scanning electronic microscopy (FESEM, JEOL JSM-6700) was employed to examine the morphology of the polyamide layers. Prior to FESEM observation, the freeze-dried TFC membranes were frozen and fractured in liquid nitrogen and coated with platinum using a JOEL JFC-1100E ion sputtering device. Atomic force microscopy (AFM, Nanoscope IIIa, Digital Instrument, USA) was used to probe the surface topology of the polyamide layers and determine the mean roughness (Ra), root mean square roughness (Rq) and surface area under the tapping mode with a scan size of 5 μm×5 μm in air. An X-ray photoelectron spectrometer (XPS, Kratos AXIS Ultra^{DLD} spectrometer, Kratos Analytical Ltd) with a mono Al K_{α} X-ray source was employed to study the elemental composition of the polyamide layers.

### Pressure Retarded Osmosis (PRO) Test

The experimental setup employed in this work for PRO tests was as described in S. Zhang et al, Chemical Engineering Journal, 2014, 241:457-465. During the tests, a 1 mol/L NaCl solution of 4 L and DI water of 1 L were employed as draw and feed solutions circulating in the lumen and shell sides of the lab-scale modules, respectively. The flow rates of both streams were controlled at 200 ml/min. The burst pressure of the TFC membranes was determined to be 25 bar. The burst pressure was determined by elevating the hydraulic pressure of the draw solution until the water flux across the TFC membranes changed the direction. Therefore, all TFC membranes were stabilised at 23 bar before the PRO tests. During the stabilisation process, the hydraulic pressure applied on the draw solution was increased from 0 bar stepwise up to 23 bar and maintained at that value for 30 minutes. After the stabilisation, the PRO performance was tested at various pressure differences from 23 bar to 0 bar at a decrement of 5 bar. There was no hydraulic pressure applied on the feed solution in all the PRO tests.

During the PRO tests, the weight loss of the feed solution was recorded as a function of time to calculate the water flux (J_{w}, L m⁻² h⁻¹, LMH) across the TFC membranes using the following equation:

$${J}_{w} = \frac{Δ {V}_{f}}{{A}_{m} Δ t} \qquad ( 1 )$$

where ΔV_{f} (L) is the variation of the feed solution volume during a measuring time interval Δt (h), and Aₘ (m²) is the effective membrane area of the lab-scale module.

The feed conductivity was recorded to estimate the variation of salt concentration in the feed solution and to calculate the reverse salt flux (Jₛ, g m⁻² h⁻¹, gMH) across the TFC membranes using the following equation:

$${J}_{s} = \frac{Δ ( {V}_{f} {C}_{f} )}{{A}_{m} Δ t} \qquad ( 2 )$$

where C_{f} and V_{f} are the salt concentration and volume of the feed solution, respectively.

The theoretical osmotic power density, W (w/m²), which is defined as the energy output per membrane area, was calculated by:

W=J_{w}ΔP (3)

where ΔP (bar) is the pressure difference across the TFC membranes.

### Results:

### Characterisation of the Synthesised CQDs

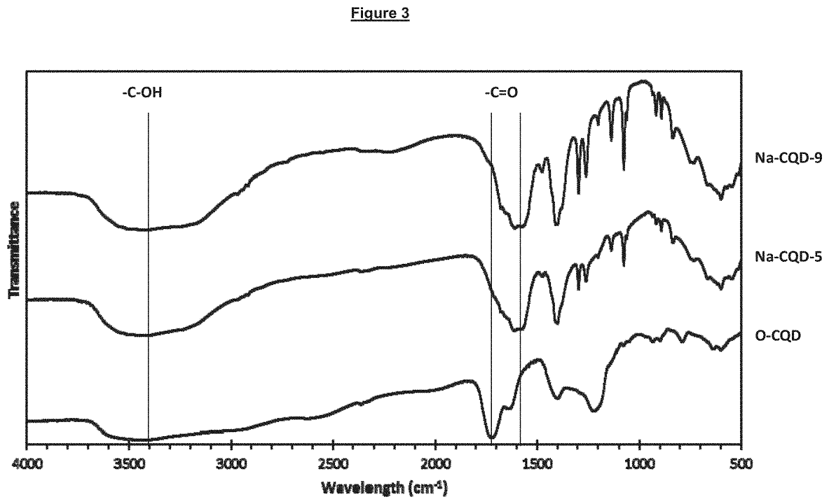

TEM images shown in FIG. 2 confirm the successful syntheses of the original CQDs (O-CQD) and Na⁺-functionalised CQDs (i.e., Na-CQD-5 and Na-CQD-9). They have a nearly spherical structure with sizes about 3 to 9 nm. The presence of Na in Na⁺-functionalised CQDs was quantitatively confirmed by XPS and Table 1 summarizes the results. A negligible Na content was detected in O-CQD, while the Na content in Na-CQD-5 and Na-CQD-9 was 10.84% and 13.57%, respectively. The Na content in Na^{t}-functionalised CQDs increased with an increase in the NaOH dose during the neutralization process. Besides, all three kinds of CQDs had high oxygen content, indicating that a large number of oxygen-containing groups existed in these CQDs.

TABLE 1
Elemental compositions (mass ratio) of the original CQDs (O-CQD)
and Na⁺-functionalised CQDs (i.e. Na-CQD-5 and Na-CQD-9)

| | O-CQD | Na-CQD-5 | Na-CQD-9 |
|---|---|---|---|
| C (%) | 52.96 | 45.93 | 50.35 |
| O (%) | 46.97 | 43.23 | 36.08 |
| Na (%) | 0.06 | 10.84 | 13.57 |

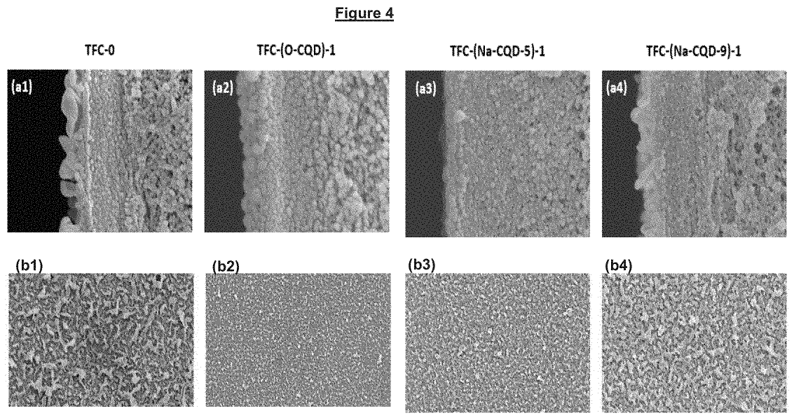

Both the ultra-fine size of CQDs and the existence of sodium and oxygen-containing groups contributed to the excellent hydrophilicity of CQDs, which allowed good dispersion of CQDs in aqueous solutions. FIG. 3 depicts the FT-IR spectra of the original CQDs and Na⁺-functionalised CQDs. The wide absorption of stretching vibrations of C—OH around 3400 cm⁻¹ and the absorption of stretching vibration of C═O at 1711.82 cm⁻¹ and 1578.73 cm⁻¹ confirm the existence of carboxyl groups in the CQDs. Therefore, three kinds of CQDs with different Na content and acid-base properties were synthesised.

Characterisation of the TFC Membranes Incorporated with Different CQDs

FIG. 4 presents the (a) cross-section and (b) surface morphology of the polyamide selective layers of the control TFC membrane and those modified with O-CQD, Na-CQD-5 and Na-CQD-9 at the same loading of 1 wt %. FIG. 4(a1) shows that the polyamide layer of the control TFC membrane (i.e. TFC-0) is an independent layer on top of the PES substrate with a thickness of around 400 nm, while FIG. 4(b1) displays that this polyamide layer has a typical ridge-and-valley surface morphology. When the MPD solution comprised 1 wt % O-CQD, the resultant polyamide layer was hardly observed for the modified TFC membrane (i.e. TFC-(O-CQD)-1), as shown in FIG. 4(a2). Moreover, as illustrated in FIG. 4(b2), this polyamide layer possesses a nodular-like surface structure instead of the typical ridge-and-valley morphology and is much smoother than TFC-0. This is attributed to the acid nature of O-CQD, which has a great number of carboxyl groups on its surface. The pH of the MPD solution containing 1 wt % O-CQD was around 5, while the pristine pH of the MPD solution was around 8-9. The acid groups on the surface of O-CQD reacted with MPD, thereby interfering the interfacial polymerization process, which means the lower the pH of the amine solution, the less amine groups available to react with TMC. In addition, the ionization of carboxyl groups generated H⁺, which inhibited the production of the by-product HCl during the interfacial polymerization reaction. As a result, the interfacial polymerization reaction was inhibited in the acid environment. Both factors contributed to a less cross-linked polyamide network with a nodular-like structure.

For the TFC membranes incorporated with Na⁺-functionalised CQDs, an independent polyamide selective layer reappeared. As shown in FIGS. 4(a3) and 4(a4), both TFC-(Na-CQD-5)-1 and TFC-(Na-CQD-9)-1 have a polyamide layer on top of their PES substrates with a thickness around 200 and 330 nm, respectively. Their top surfaces also exhibited the typical ridge-and-valley morphology, as shown in FIGS. 4(b3) and (b4). Compared with TFC-0, TFC-(Na-CQD-5)-1 had smaller leaves contributing to a relatively smoother surface, while TFC-(Na-CQD-9)-1 had bigger leaves and more intensive leaves per membrane area contributing to a relatively rougher surface.

The interfacial polymerization reaction may be described into two stages: (1) MPD monomers in the water phase diffuse towards the organic phase and react with TMC monomers, forming the nascent polyamide layer without the obvious ridge-and-valley structure and (2) the surface tension between the water phase and organic phase prompts further migration of MPD monomers to react with TMC monomers, pushing and twisting the nascent polyamide selective layer and resulting in a ridge-and-valley structure. In the present case, the Na⁺-functionalised CQDs dissolved in the MPD solution not only interfered with the crosslinking reaction between the two monomers but also changed the surface tension between the water and organic phases. The former factor led to a relatively looser polyamide network, enhancing the MPD migration together with the latter factor to form a polyamide network with a high degree of crosslinking. Because the MPD solutions had different pH values of around 6.5 and 9 respectively when synthesizing TFC-(Na-CQD-5)-1 and TFC-(Na-CQD-9)-1, TFC-(Na-CQD-5)-1 had (1) less amine groups available for reaction and (2) more ionized H⁺ existing to inhibit the reaction than TFC-(Na-CQD-9)-1. As a result, the former had a thinner and smoother polyamide layer than the latter.

To further characterize the control TFC membrane and those modified with O-CQD, Na-CQD-5 and Na-CQD-9 at the same loading, the surface topology of polyamide layers was probed by AFM, and the measured data is listed in Table 2.

TABLE 2
Characteristics of the polyamide selective layers of the TFC membranes

| | TFC-0 | TFC-(O- | TFC-(Na- | TFC-(Na- |
|---|---|---|---|---|
| | (control) | CQD)-1 | CQD-5)-1 | CQD-9)-1 |
| Rq (nm) | 90.39 ± 6.98 | 38.03 ± 1.74 | 64.57 ± 5.17 | 100.40 ± 8.31 |
| Ra (nm) | 71.51 ± 5.28 | 29.53 ± 1.22 | 48.52 ± 5.99 | 80.40 ± 6.16 |
| Surface | 33.30 ± 2.10 | 36.24 ± 0.76 | 40.50 ± 2.38 | 47.63 ± 1.24 |
| area (nm²) | | | | |

The order of roughness was quite consistent with what was observed from the FESEM images. TFC-(O-CQD)-1 and TFC-(Na-CQD-5)-1 had a smaller roughness than TFC-0, while TFC-(Na-CQD-9)-1 had a larger roughness than TFC-0. Compared with TFC-0, the surface areas of TFC-(O-CQD)-1, TFC-(Na-CQD-5)-1 and TFC-(Na-CQD-9)-1 increased by 8.83, 21.62 and 43.03%, respectively, which is consistent with the increasing trend of Na content in CQDs. Although TFC-(O-CQD)-1 and TFC-(Na-CQD-5)-1 had a smaller roughness than TFC-0, all the TFC membranes embedded with CQDs had a larger surface area as compared to TFC-0, which proves the enhanced migration of the MPD monomers due to the incorporation of CQDs.

Table 3 summarizes chemical compositions of polyamide layers in the control and modified TFC membranes analysed by XPS. As expected, Na is hardly detected by XPS due to its low content in the polyamide selective layers of all modified TFC membranes. Compared with TFC-0, the polyamide layers of the modified TFC membranes have higher O content and O/C ratios due to the incorporation of CQDs, which have high oxygen content as shown in Table 1. The higher O content and O/C ratios in the modified polyamide layers implies the existence of more oxygen-containing groups in TFC-(O-CQD)-1, TFC-(Na-CQD-5)-1 and TFC-(Na-CQD-9)-1, which leads to higher membrane hydrophilicity. It should be noticed that the O content in the polyamide layers of TFC-(O-CQD)-1, TFC-(Na-CQD-5)-1 and TFC-(Na-CQD-9)-1 show an increasing trend, which is contrary to the decreasing trend of oxygen content in their respective incorporated CQDs. This phenomenon may be attributed to the increased crosslinking degree of the polyamide layer, as witnessed by the increased N content in their corresponding polyamide layers. In other words, the higher the crosslinking degree, the more CQDs are incorporated into the polyamide layer. It should be noticed that the TFC-(O-CQD)-1 has a lower crosslinking degree as suggested by the lower N contents compared with TFC-0, which is consistent with FIGS. 4(a2) and (b2).

TABLE 3
Surface elemental compositions (mass ratio) of polyamide
selective layers of the TFC membranes

| | TFC-0 | TFC-(O- | TFC-(Na- | TFC-(Na- |
|---|---|---|---|---|
| | (control) | CQD)-1 | CQD-5)-1 | CQD-9)-1 |
| Na (%) | 0.09 | 0.10 | 0.06 | 0.06 |
| O (%) | 12.74 | 14.79 | 15.88 | 16.91 |
| C (%) | 82.78 | 81.22 | 78.69 | 75.37 |
| N (%) | 4.40 | 3.89 | 5.36 | 7.66 |
| O/C | 0.15 | 0.18 | 0.20 | 0.22 |

PRO Performance of TFC Membranes Incorporated with Different CQDs

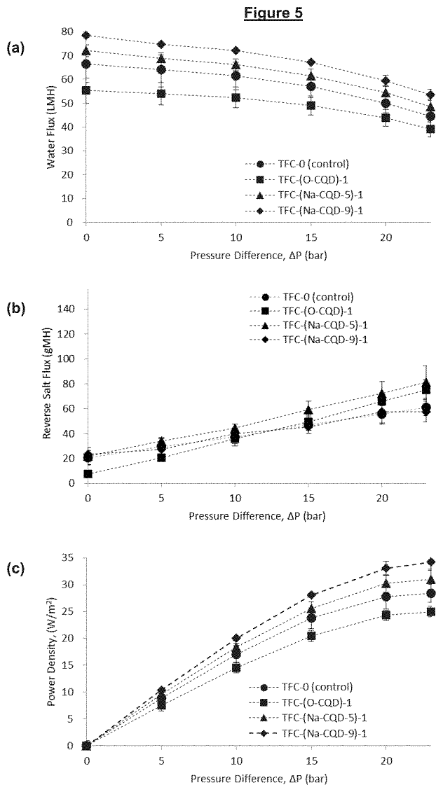

FIG. 5 summarises the water flux, reverse salt flux and power density as a function of pressure difference (ΔP) across the membrane for the control and modified TFC membranes. For TFC-0, the water flux decreased from 66.59 to 44.52 LMH when ΔP was increased from 0 to 23 bar. Similarly, the water fluxes of the CQDs modified TFC membranes monotonically decreased with an increase in ΔP. In general, compared with TFC-0, TFC-(O-CQD)-1 had a lower water flux, while both TFC-(Na-CQD-5)-1 and TFC-(Na-CQD-9)-1 had higher water fluxes, and TFC-(Na-CQD-9)-1 showed the highest water flux.

The reverse salt fluxes of all TFC membranes rose monotonically with an increase in ΔP. They overlapped one another within the pressure range from 0 to 15 bar. However, the CQDs modified TFC membranes had slightly higher reverse salt fluxes than TFC-0 at high ΔP (i.e., 20 and 23 bar) due to their relatively looser polyamide layers because of the incorporation of the CQDs. However, it should be noticed that the highest reverse salt flux of the modified TFC membranes was only 81.34 gMH for TFC-(Na-CQD-5)-1, which implied no significant defects were formed in the polyamide layers after the incorporation of CQDs at this loading. The power density of all TFC membranes was almost proportional to ΔP within the pressure range of 0 to 23 bar. Thus, the peak power density was achieved at 23 bar. The respective power densities for TFC-0, TFC-(O-CQD)-1, TFC-(Na-CQD-5)-1 and TFC-(Na-CQD-9)-1 at 23 bar were 28.44, 24.98, 31.03 and 34.20 W/m². Compared with TFC-0, the peak power densities of TFC-(O-CQD)-1, TFC-(Na-CQD-5)-1 and TFC-(Na-CQD-9)-1 increased at −12.18, 9.12 and 20.27%, respectively.

In summary, the dissolution of CQDs into the MPD aqueous solution indeed influences the interfacial polymerization reaction between the amine and acyl chloride monomers, resulting in TFC membranes with different morphology and performance. However, the incorporation of nanoscale CQDs into the polyamide selective layers at 1 wt % loading does not induce significant defects. All TFC membranes showed a low reverse salt flux. The deteriorated water flux and power density of TFC-(O-CQD)-1 were a result of the decreased crosslinking degree in the polyamide layer because of the acid nature of O-CQD, while the incorporation of Na⁺-functionalised CQDs significantly enhanced the water flux and power density, especially for the TFC membranes containing Na-CQD-9. This is attributed to four factors: (1) the decreased polyamide layer thickness in TFC-(Na-CQD-5)-1 and TFC-(Na-CQD-9)-1; (2) the increased surface area due to the increased crosslinking degree; (3) a looser polyamide network due to the interference of the crosslinking between the two monomer with the presence of the NaCQDs; and (4) the increased membrane hydrophilicity due to the increased oxygen-containing groups in the polyamide layer.

Characterisation of the TFC Membranes Incorporated with Na-CQD-9 at Different Loadings

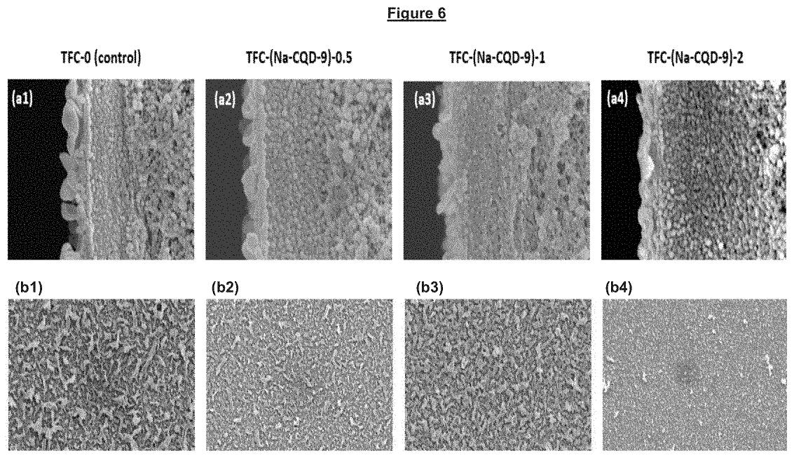

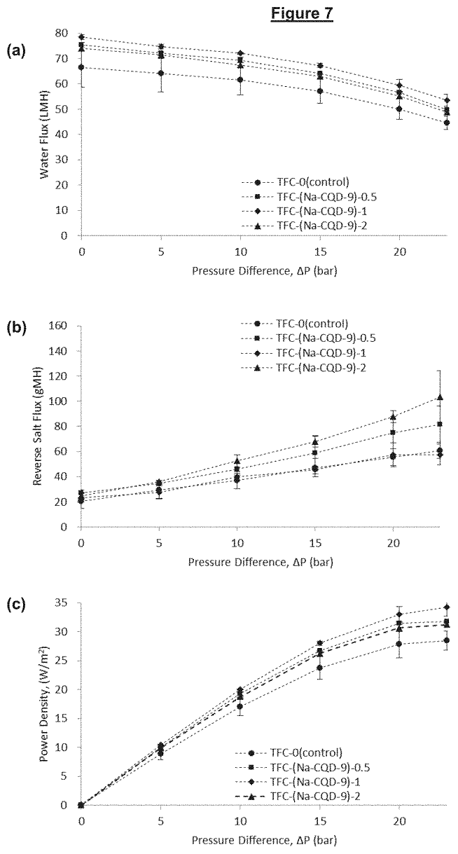

FIG. 6 shows the micrographs of (a) cross-section and (b) surface of the polyamide layers of the control and modified TFC membranes as a function of Na-CQD-9 loading. For all modified TFC membranes, an independent polyamide layer was observed on top of PES substrates with a thickness of around 300 nm. A comparison between FIGS. 6(b2) and (b3) indicates that TFC-(Na-CQD-9)-0.5 had quite a similar polyamide surface morphology with TFC-(Na-CQD-9)-1 but the former had smaller leaves and a smoother surface than the latter. Interestingly, TFC-(Na-CQD-9)-2 had a more nodular-like surface structure, as illustrated in FIG. 6(b4). As a result, it had a smoother surface than TFC-0, TFC-(Na-CQD-9)-0.5 and TFC-(Na-CQD-9)-1. As discussed above, the presence of Na-CQD-9 not only interfered with the crosslinking reaction between the two monomers leading to a relatively looser polyamide network, but also changed the surface tension between the water and organic phases. Both factors enhanced the MPD migration and formed a polyamide network with a high crosslinking degree. Compared with TFC-(Na-CQD-9)-1, TFC-(Na-CQD-9)-0.5 had a relatively denser polyamide selective layer and less MPD migration to the organic phase due to the lower concentration of Na-CQD-9, while TFC-(Na-CQD-9)-2 had a relatively looser polyamide selective layer and more MPD migration to the organic phase due to the higher concentration of Na-CQD-9. As a result, the leaves of TFC-(Na-CQD-9)-2 were connected together to form a smoother surface as shown in FIGS. 6(a4) and (b4).

Table 4 summarizes the surface topology of the polyamide layers on the control TFC membrane and those containing Na-CQD-9 at different loadings probed by AFM. The results were quite consistent with the observation from FESEM images. Both TFC-(Na-CQD-9)-0.5 and TFC-(Na-CQD-9)-2 had a smaller roughness than TFC-(Na-CQD-9)-1. Compared with TFC-0, TFC-(Na-CQD-9)-0.5 and TFC-(Na-CQD-9)-1 had an enlarged surface area, while TFC-(Na-CQD-9)-2 had a decreased surface area. Among the modified TFC membranes, TFC-(Na-CQD-9)-1 had the highest surface area.

TABLE 4
Characteristics of the polyamide selective layers of the TFC membranes

| | TFC-0 | TFC-(Na- | TFC-(Na- | TFC-(Na- |
|---|---|---|---|---|
| | (control) | CQD-9)-0.5 | CQD-9)-1 | CQD-9)-2 |
| Rq (nm) | 90.39 ± 6.98 | 73.81 ± 3.08 | 100.40 ± 8.31 | 21.80 ± 1.33 |
| Ra (nm) | 71.51 ± 5.28 | 58.66 ± 2.47 | 80.40 ± 6.16 | 14.78 ± 0.83 |
| Surface | 33.30 ± 2.10 | 44.11 ± 0.62 | 47.63 ± 1.24 | 29.20 ± 0.45 |
| area (nm²) | | | | |

Table 5 tabulates their surface chemical compositions as a function of Na-CQD-9 loading analysed by XPS. As expected, all modified TFC membranes had negligible Na content in the polyamide layers. The O content and O/C ratio of the polyamide layer showed an increasing trend from TFC-0, TFC-(Na-CQD-9)-0.5, TFC-(Na-CQD-9)-1 to TFC-(Na-CQD-9)-2 due to the increased Na-CQD-9 loading, indicating the increasing of oxygen-containing groups' existence and membrane hydrophilicity. The N content in the polyamide layers of TFC-(Na-CQD-9)-0.5, TFC-(Na-CQD-9)-1 and TFC-(Na-CQD-9)-2 were all higher than that of TFC-0, suggesting the former had a higher degree of crosslinking in the polyamide layers than the latter.

TABLE 5
Surface elemental compositions (mass ratio) of polyamide
selective layers of the TFC membranes

| | TFC-0 | TFC-(Na- | TFC-(Na- | TFC-(Na- |
|---|---|---|---|---|
| | (control) | CQD-9)-0.5 | CQD-9)-1 | CQD-9)-2 |
| Na (%) | 0.09 | 0.06 | 0.06 | 0.03 |
| O (%) | 12.74 | 15.09 | 16.91 | 21.51 |
| C (%) | 82.78 | 77.65 | 75.37 | 71.00 |
| N (%) | 4.40 | 7.20 | 7.66 | 7.47 |
| O/C | 0.15 | 0.19 | 0.22 | 0.30 |

PRO Performance of TFC Membranes Incorporated with Na-CQD-9 at Different Loadings

FIG. 7 shows the water flux, reverse salt flux and power density of the control and Na-CQD-9 incorporated TFC membranes as a function of ΔP. All TFC membranes comprising Na-CQD-9 had higher water fluxes and power density than TFC-0 due to the decreased thickness, increased existence of hydrophilic oxygen-containing groups, increased surface area and looser polyamide network of the polyamide selective layers. TFC-(Na-CQD-9)-0.5 had a relatively lower water flux and power density than TFC-(Na-CQD-9)-1 because of the smaller surface area, denser polyamide network and less oxygen-containing groups in the polyamide layer, while TFC-(Na-CQD-9)-2 showed a relatively lower water flux and power density than TFC-(Na-CQD-9)-1 because of the smaller surface area of the polyamide selective layer and the increased ICP effect caused by the increased reverse salt flux. It should be noticed that TFC-(Na-CQD-9)-2 had a reverse salt flux of 103.8 gMH, which was almost double the value of TFC-(Na-CQD-9)-1. The remarkable increment in reverse salt flux was caused by the defects formed in the polyamide layer when the Na-CQD-9 loading was too high. As a conclusion, the addition of 1 wt % Na-CQD-9 into the MPD aqueous solution was the optimal condition, which not only induced a desirable water flux and power density but also maintained a low salt reverse flux.

RO Performance of TFC Membranes Incorporated with 1 wt % Na-CQD-9

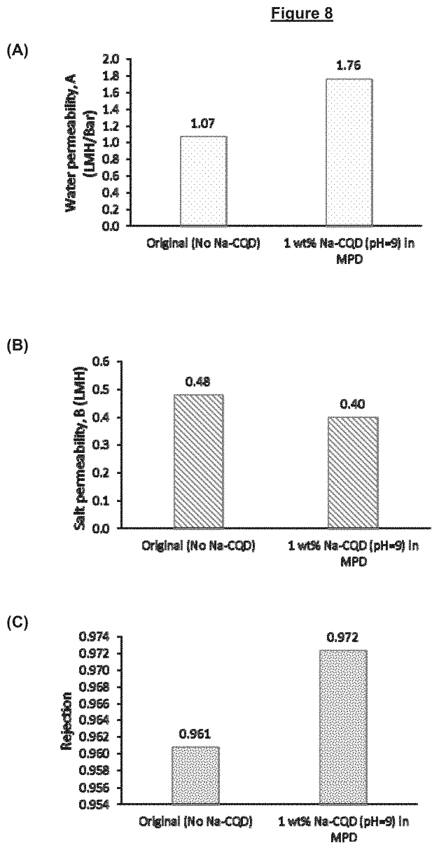

FIG. 8 shows the water permeability and salt permeability of the TFC membranes under RO mode. For the TFC-(Na-CQD-9)-1 membrane, the water permeability (PWP) was 1.76 LMH/bar, which was 64.49% higher than the control membrane. Meanwhile, the salt rejection of the TFC membranes improved after the incorporation of the NaCQDs.

### Conclusion

From the above, it could be seen that the pH of the MPD solution significantly influenced the interfacial polymerisation process. Compared with an acidic MPD solution, a basic MPD solution was more preferable to form a polyamide layer with a ridge-and-valley structure and a larger surface area for water transport. The incorporation of NaCQDs, especially Na-CQD-9, significantly enhanced the water flux and power density by decreasing the thickness of the polyamide layer, increasing the oxygen-containing groups and surface area of the polyamide layer, and forming a looser polyamide network on TFC membranes. The TFC membrane comprising 1 wt % NaCQD exhibited a peak power density as high as 34.20 W/m² at 23 bar using 1.0 M NaCl solution and deionised water as the feed pair for osmotic power generation.

### Example 2

### Chemicals and Materials

The porous hollow fibre substrates were prepared using Veradel 3100P polyethersulfone (PES, Solvay Specialty Polymers), polyethylene glycol 400 (PEG, Mw=400 g/mol, Acros Organics), N-methyl-2-pyrrolidone (NMP, 99.5%, Merck) and glycerol (Industrial grade, Aik Moh Pains & Chemicals Pte. Ltd.). The polyamide layers were deposited on top of the inner surface of the porous substrates by interfacial polymerization using 1,3,5-benzenetricarbonyl trichloride (TMC, 98%, Sigma-Aldrich) in hexane (99.9%, Fisher Chemicals) and m-Phenylenediamine (MPD, 98%, T.C.I.) in aqueous solutions containing sodium dodecyl sulfate (SDS, 99%, Sigma-Aldrich). The CQDs were synthesized from citric acid (99.5%, Sigma-Aldrich) and then functionalized with sodium hydroxide (98%, Sigma-Aldrich) to produce NaCQDs. Sodium chloride (NaCl, 99.5%, Merck) was acquired for membrane performance tests. All chemicals were used as received without further purification. Deionized (DI) water produced by a Milli-Q ultrapure water system (Millipore, USA) was used throughout the experiments

### Syntheses and Characterisation of CQDs and NaCQDs

The CQDs and the NaCQDs were synthesised as described in Example 1 with the exception that for NaCQDs, the neutralising the residues after dialysis was with a NaOH aqueous solution (5.0 M) to a pH value of 8.

The particle size and morphology of CQDs and NaCQDs were characterized using high-resolution transmission electron microscopy (HR-TEM, JEOL JEM-2100F). Fourier transform infrared spectroscopy (FT-IR, Vertex 70, Bruker, USA) with a wavenumber range of 4000-500 cm⁻¹ and an X-ray photoelectron spectrometer (XPS, Kratos AXIS Ultra^{DLD} spectrometer, Kratos Analytical Ltd) with a mono Al K_{α} X-ray source were employed to determinate the functional groups and chemical compositions of CQDs and NaCQDs.

### Fabrication of Porous Hollow Fibre Substrates

The hollow fibre substrates were prepared in the same manner as described in Example 1. Each module comprised three pieces of hollow fibre substrates with a length of about 14 cm.

### Fabrication of TFC Hollow Fibre Membranes

A thin selective polyamide layer was deposited on top of the inner surface of each hollow fibre substrate via interfacial polymerization. For the conventional TFC membranes, a 2 wt % MPD aqueous solution comprising 0.1 wt % SDS was firstly introduced into the lumen of the substrates for 3 minutes at a flow rate of 4.25 ml/min, then followed by air purging through the lumen for 5 minutes in order to strip away the excessive MPD solution. Subsequently, a TMC-hexane solution of 0.15 wt % was introduced into the lumen of the substrates for 5 minutes at a flow rate of 2.50 ml/min to react with the MPD monomer, then followed by air purging through the lumen of the substrates for 1 minute to strip away the excessive TMC solution.

For the TFC membranes comprising CQDs or NaCQDs in the polyamide layers (referred to in this example as thin film nanocomposite (TFN) membrane), the nanomaterials were added into the MPD aqueous solutions at 1 wt % following the same procedures as those for the conventional TFC membranes. The resultant TFN membranes were denoted as TFN-(CQDs)-1 and TFN-(Na-CQDs)-1, respectively, where 1 means 1 wt % CQDs or NaCQDs in the MPD aqueous solutions. After interfacial polymerization, the prepared lab-scale modules comprising TFC and TFN membranes were left in air overnight and then immersed in DI water for at least one day before the tests.

### Characterisation of TFC and TFN Hollow Fibre Membranes

To study the differences between the conventional TFC membranes and the TFN membranes incorporating the CQDs and NaCQDs, various characterisation techniques were utilized. Prior to the characterisations, the membranes were taken out from the lab-scale modules and immersed in DI water for at least one day to remove the potential contaminants before being freeze dried. Field emission scanning electronic microscopy (FESEM, JEOL JSM-6700) was used to observe their morphology. The membrane samples for FESEM observation were fractured in liquid nitrogen and coated with platinum using a JOEL JFC-1100E ion sputtering device. Atomic force microscopy (AFM, Nanoscope IIIa, Digital Instrument, USA) was utilized to determine their mean roughness (Ra), root mean square roughness (Rq) and effective surface area with a scan size of 5 μm×5 μm under a tapping mode in air. X-ray photoelectron spectrometer (XPS, Kratos AXIS Ultra^{DLD} spectrometer, Kratos Analytical Ltd) with a mono Al K_{α} X-ray source was employed to study the chemical compositions of their polyamide layers.

### Performance Tests of TFC and TFN Hollow Fibre Membranes

The performance of the TFC and TFN membranes was evaluated in terms of pure water permeability (PWP or A, L m⁻² h⁻¹/bar, LMH/bar), salt permeability (B, L m⁻² h⁻¹, LMH), water flux (J_{w}, L m⁻² h⁻¹, LMH) and solute rejection (R) using lab-scale modules comprising three pieces of hollow fibre membranes with an effective area of about 8 cm². The experimental setup used was as described in Example 1. One of the two pre-determined stabilisation pressures (i.e. 15 bar or 23 bar) had been applied for 1 hour before the membrane performance was evaluated at 15 bar. Membrane performance under the same stabilisation condition (i.e. 15 bar) was compared to study the effects of the incorporation of CQDs and NaCQDs. Membrane performance under different stabilisation conditions (i.e. 15 bar vs. 23 bar) was compared to study the effects of high-pressure stabilisation on the separation performance of hollow fibre membranes. The pressure of 23 bar was chosen because the burst pressure of these membranes was 25 bar, which was determined by elevating the hydraulic pressure in their lumen until the hollow fibre membranes collapsed.

To measure PWP, DI water was pumped into the lumen of the lab-scale modules at a flow rate of 200 ml/min. The water permeate at the shell side of hollow fibre membranes was collected at 15 bar after the membranes had been stabilised at 15 bar or 23 bar for one hour. PWP was calculated using the equation below:

$$A = \frac{Δ V}{{A}_{m} Δ t Δ P} \qquad ( 4 )$$

where ΔV (L) is the volumetric variation of water permeation during a time interval Δt (h) under a trans-membrane pressure of ΔP (bar), and Δₘ (m²) is the effective membrane area of the lab-scale modules.

To measure the salt permeability, water flux and solute rejection, a 2000 ppm NaCl feed solution was pumped into the lumen of the lab-scale modules at a flow rate of 200 ml/min, and the permeate was collected at 15 bar after the TFC and TFN membranes had been stabilised at 15 bar or 23 bar for 1 hour. The water flux across the membranes was evaluated using the equation below:

The feed conductivity was recorded to estimate the variation of salt concentration in the feed solution and to calculate the reverse salt flux (Jₛ, g m⁻² h⁻¹, gMH) across the TFC membranes using the following equation:

$${J}_{w} = \frac{Δ V}{{A}_{m} Δ t} . \qquad ( 5 )$$

The conductivity of the feed and permeate was measured to determine the salt rejection and salt permeability using the equations below:

$$\begin{matrix}R = ( 1 - \frac{{Cd}_{p}}{{Cd}_{f}} ) \times 100 \% & ( 6 ) \\ B = \frac{1 - R}{R} ( Δ P - Δ π ) A & ( 7 )\end{matrix}$$

where Cdₚ (μs/cm) and Cd_{f} (μs/cm) are the conductivity of the permeate and feed solution, respectively; Δπ is the osmotic pressure difference across the membranes.

### Results:

### Characterisations of CQDs and NaCQDs

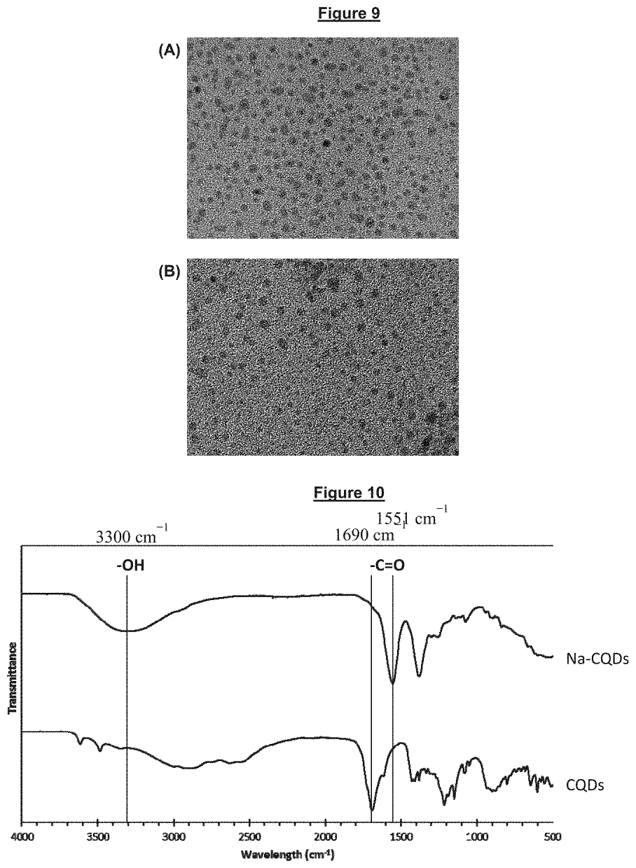

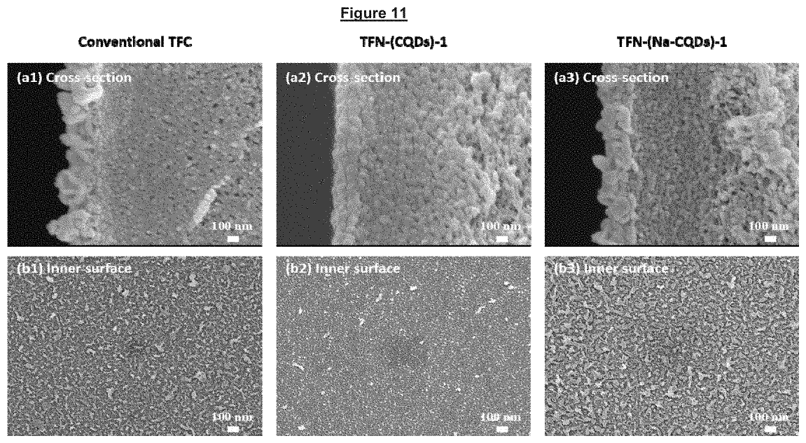

FIG. 9 displays the TEM images of both CQDs and NaCQDs. They are well dispersed without agglomeration and have a nearly spherical shape with a similar size range between 2 and 6 nm. FIG. 10 shows the surface chemistry of CQDs and NaCQDs investigated by FT-IR. The wide absorption around 3300 cm⁻¹ and the absorption at 1690 cm⁻¹ correspond to the stretching vibrations of the hydroxyl groups and carboxyl groups existing in CQDs, respectively. Interestingly, the absorption of the carboxyl groups of NaCQDs shifts to 1551 cm⁻¹. The existence of these hydrophilic oxygen-containing groups in CQDs and NaCQDs make them highly hydrophilic. Table 6 summarizes the chemical compositions of CQDs and NaCQDs analysed by XPS.

TABLE 6
XPS analysis results (mass ratio, %) of the CQDs and
Na⁺-functionalised CQDs (i.e. Na-CQD)

| | CQD | Na-CQD |
|---|---|---|
| C (%) | 58.10 | 53.34 |
| O (%) | 41.90 | 33.81 |
| Na (%) | 0.00 | 12.85 |

Both CQDs and NaCQDs have high oxygen content indicating the existence of large amounts of hydrophilic oxygen-containing groups, which is in consistent with the FT-IR analyses. The Na content in NaCQDs was 12.85%, while there was no Na existing in CQDs. Not only the existence of oxygen-containing groups but also the existence of sodium imparts the NaCQDs with excellent hydrophilicity, which makes them highly dispersible in aqueous solutions.

### Physiochemical Changes Due to CQDs and NaCQDs Incorporation

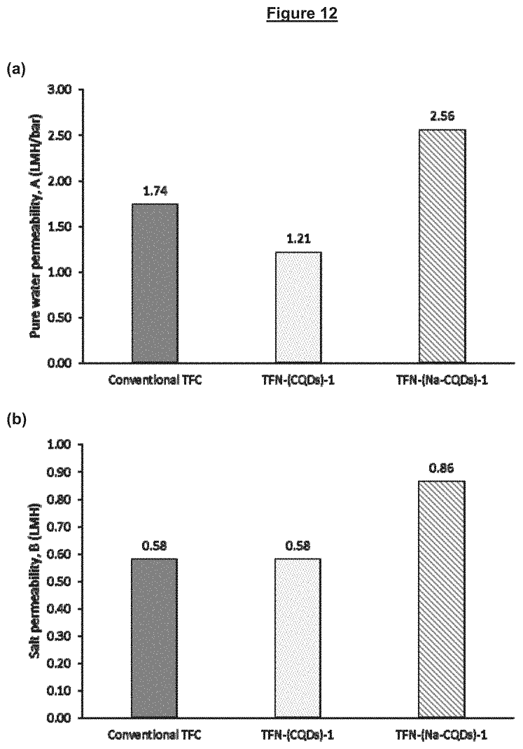

FESEM was employed to study the effects of CQDs and NaCQDs incorporation on the morphology of polyamide layers. FIG. 11 compares the cross-section and surface morphology of the polyamide layers of the TFC and TFN membranes. As shown in FIGS. 11(a1 and b1), the conventional TFC membrane has a polyamide layer apparently as an independent layer on top of the porous substrate with a thickness of around 426 nm and a typical ridge-and-valley surface morphology. In contrast, the polyamide layer of the TFN membrane incorporated with CQDs (i.e., TFN-(CQDs)-1) not only could be hardly distinguished as an extra layer from the substrate due to the significantly decreased thickness (FIG. 11(a2)), but also had a much smoother nodular-like surface morphology (FIG. 11(b2)). The cause for the decreased thickness and smoother surface resulted from the acidic properties of CQDs. In other words, the pH value of the as synthesized CQDs aqueous solution before being freeze-dried was about 2. The addition of CQDs into the MPD aqueous solution caused a drop in pH value from about 8-9 to about 5. Under this circumstance, the acid groups of CQDs reacted with the MPD monomer, which resulted in a decrease in the available amount of amine groups for interfacial polymerization. In addition, the H⁺ generated from the ionization of carboxyl groups tended to inhibit the reaction between MPD and TMC monomers, whose by-product was HCl. As a result, the acidic MPD solution comprising CQDs tended to have a lower degree of reaction with the TMC solution forming a nodular-like polyamide selective layer with a smaller thickness and roughness.

Interestingly, the typical ridge-and-valley morphology re-appeared on the polyamide layer of the TFN membrane incorporated with NaCQDs (i.e., TFN-(Na-CQDs)-1), and the polyamide layer could again be distinguished as an independent layer on top of the substrate with a thickness of about 343 nm, as illustrated in FIGS. 11(a3 and b3). A comparison of its surface morphology with that of the conventional TFC membrane, the former had more and broader leaves than the latter. As a result, the TFN-(Na-CQDs)-1 had a polyamide layer with the highest roughness among the three kinds of membranes. This morphological change was mainly due to the effects of NaCQDs incorporation during the interfacial polymerization process. Usually, MPD molecules in the aqueous phase tend to diffuse across the interface to react with TMC molecules. The diffusion of MPD slowed down gradually due to the formation of a nascent polyamide network. When the polyamide network became dense and thick enough, it stopped the MPD diffusion and terminated the interfacial polymerization. The addition of NaCQDs into the MPD aqueous solution induced additional interstitial space among the nascent polyamide network and resulted in more MPD diffusing towards the organic phase and reacting with TMC. As a result, the polyamide layer of TFN-(Na-CQDs)-1 had more and broader leaves formed on its surface accompanying with a decreased thickness.

Table 7 summarizes the roughness and effective surface area of the polyamide layers measured by AFM.

TABLE 7
Characteristics of the polyamide selective layers of the TFC and TFN
membranes

| | Conventional TFC | TFN-(CQDs)-1 | TFN-(Na-CQDs)-1 |
|---|---|---|---|
| Rq (nm) | 60.16 ± 6.44 | 23.96 ± 2.29 | 96.76 ± 2.88 |
| Ra (nm) | 46.98 ± 4.54 | 15.83 ± 0.88 | 78.55 ± 2.36 |
| Effective | 38.14 ± 0.50 | 29.39 ± 0.27 | 46.10 ± 1.58 |
| surface area | | | |
| (μm²) | | | |

Consistent with the observations from FESEM images, the polyamide layer of TFN-(CQDs)-1 had a lower roughness than the conventional TFC membrane due to the lower degree of reaction between the acidic MPD solution and the TMC solution, while the polyamide layer of TFN-(Na-CQDs)-1 had a higher roughness than the conventional TFC membrane due to the diffusion of more MPD to react with TMC. In terms of effective surface area, the polyamide layer of TFN-(CQDs)-1 had the smallest one because it possessed a nodular-like morphology instead of the typical ridge-and-valley morphology observed for the conventional TFC membrane and TFN-(Na-CQDs)-1. Since TFN-(Na-CQDs)-1 had a polyamide layer with more and broader leaves on its surface than the conventional TFC membrane, the former had an effective surface area 21.43% larger than the latter (i.e., 46.10 μm² vs. 38.14 μm²). The higher roughness would benefit the water transport across the membranes due to the larger effective surface area, leading to a higher water permeability and flux.

Table 8 shows the XPS results reflecting the effects of CQDs and NaCQDs incorporation on the chemical compositions of polyamide layers.

TABLE 8
XPS analysis results (mass ratio, %) of polyamide selective layers
of the TFC and TFN membranes

| | Conventional TFC | TFN-(CQDs)-1 | TFN-(Na-CQDs)-1 |
|---|---|---|---|
| Na (%) | 0.10 | 0.06 | 0.06 |
| O (%) | 16.88 | 18.63 | 19.69 |
| C (%) | 76.10 | 75.66 | 72.88 |
| N (%) | 6.92 | 5.65 | 7.36 |
| O/C (%) | 22.18 | 24.62 | 27.02 |

Both TFN-(CQDs)-1 and TFN-(Na-CQDs)-1 have slightly higher O content and O/C ratio in their polyamide layers than the conventional TFC membrane due to the incorporation of highly oxygen-containing CQDs and NaCQDs. The higher O content and O/C ratio imply that the polyamide layers of TFN membranes had more hydrophilic oxygen-containing groups in their surface, which benefit the water transport across the membranes. Besides, the incorporation of CQDs and Na-CQDs would also affect the N content of the polyamide layers, which could be regarded as an indicator for the degree of reaction for interfacial polymerization. A comparison of N content among these three membranes showed that TFN-(CQDs)-1 had the lowest N content, while TFN-(Na-CQDs)-1 had the highest N content. Therefore, the degree of reaction between MPD and TMC monomers followed the order of TFN-(Na-CQDs)-1>conventional TFC>TFN-(CQDs)-1. This sequence was exactly the same as the orders of roughness and effective surface area. Due to the relatively low amount of Na content in NaCQDs, the Na content in the polyamide layer could hardly be detected by XPS.

### Performance Changes Due to CQDs and NaCQDs Incorporation

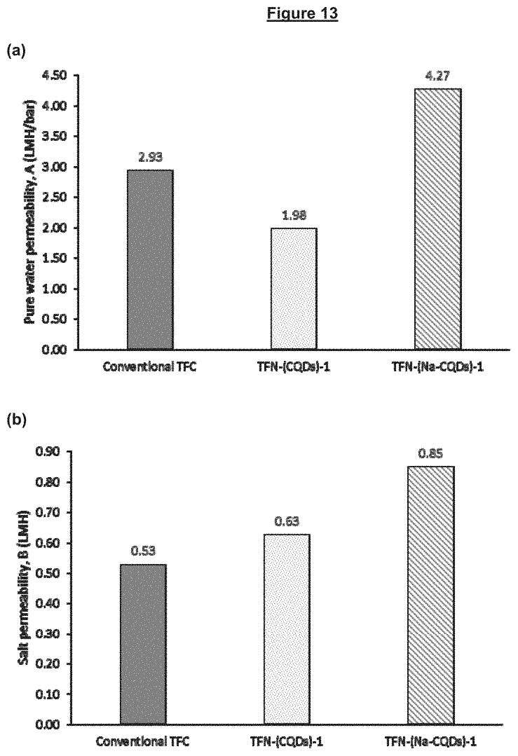

The water permeate across membranes was collected at 15 bar after the hollow fibre membranes had been stabilised at 15 bar for 1 hour to determine the effects of CQDs and NaCQDs incorporation on membrane performance. FIG. 12 summarizes the PWP (A) and salt permeability (B) of the conventional TFC membrane and CQDs and NaCQDs incorporated TFN membranes. The A and B values of the conventional TFC membrane are 1.74 LMH/bar and 0.58 LMH, respectively. After the incorporation of CQDs into the polyamide layer, the A value of TFN-(CQDs)-1 decreased to 1.21 LMH/bar due to the dramatic decrease in both membrane roughness and effective surface area, while its B value maintained as the same as that of the conventional TFC membrane. In contrast, the A value of TFN-(Na-CQDs)-1 increased to 2.56 LMH/bar accompanied by a slight increase in the B value to 0.86 LMH. Compared to the conventional TFC membrane, the 47.13% increase in the A value arose from the physicochemical changes which happened to the polyamide layer as a result of NaCQDs incorporation, such as a decreased membrane thickness, an increased effective surface area, more hydrophilic oxygen-containing groups and an increased interstitial space among the polyamide chains.

Table 9 compares the water fluxes and solute rejections of the conventional TFC membrane and CQDs and NaCQDs incorporated TFN membranes for brackish water desalination using a 2000 ppm NaCl aqueous solution as the feed.

TABLE 9
Water flux and NaCl rejection of the TFC and TFN membranes

| | | Testing | | NaCl |
|---|---|---|---|---|
| | Stabilisation | pressure | Water flux | Rejection |
| | conditions | (bar) | (LMH) | (%) |
| Conventional | 15 bar for 1 hour | 15 bar | 24.25 ± 2.80 | 97.7 ± 0.19 |
| TFC | 23 bar for 1 hour | | 39.22 ± 3.62 | 98.7 ± 0.33 |
| TFN-(CQDs)-1 | 15 bar for 1 hour | 15 bar | 16.95 ± 1.71 | 96.7 ± 0.63 |
| | 23 bar for 1 hour | | 26.74 ± 3.50 | 97.8 ± 0.62 |
| TFN-(Na- | 15 bar for 1 hour | 15 bar | 34.86 ± 1.41 | 97.7 ± 0.48 |
| CQDs)-1 | 23 bar for 1 hour | | 57.65 ± 3.26 | 98.6 ± 0.35 |

The conventional TFC membrane had a water flux and solute rejection of 24.25 LMH and 97.7%, respectively. Similar to the effects of CQDs and NaCQDs incorporation on the A values, the water flux of TFN-(CQDs)-1 dropped to 16.95 LMH, while that of TFN-(Na-CQDs)-1 dramatically jumped to 34.86 LMH, which is a 43.75% increment compared with the conventional TFC membrane. Meanwhile, the NaCl rejection of TFN-(CQDs)-1 decreased to 96.7% due to the combined effects of the enlarged interstitial space among polyamide chains and the decreased degree of reaction between MPD and TMC monomers. In contrast, although the incorporation of NaCQDs into the polyamide layer enlarged the interstitial space among polyamide chains, its negative effects on NaCl rejection was compensated by the positive effects induced by the increased degree of reaction between MPD and TMC. As a result, TFN-(Na-CQDs)-1 had the same NaCl rejection as the conventional TFC membrane, which means that the incorporation of 1 wt % NaCQDs into the polyamide layer did not induce any significant defects.

### Advantages of the Hollow Fibre Configuration for Brackish Water Desalination

The water permeate across membranes was still collected at 15 bar, while a higher stabilisation pressure had been applied to hollow fibre membranes so that the effects of high-pressure stabilisation on separation performance could be illustrated. FIG. 13 shows the A and B values tested at 15 bar after the hollow fibre membranes had been stabilised at 23 bar for 1 hour. A higher stabilisation pressure did not change the effects of CQDs and NaCQDs incorporation on membrane performance, so the general trends of A and B values in FIG. 13 are almost the same as those in FIG. 12. TFN-(Na-CQDs)-1 had the highest A value of 4.27 LMH/bar. A comparison between FIGS. 12 and 13 indicates that the stabilisation at 23 bar instead of 15 bar makes the A values jump 68.39%, 63.64% and 66.80% for the conventional TFC, TFN-(CQDs)-1 and TFN-(Na-CQDs)-1 membranes, respectively. The dramatic enhancement is explainable by the deformation of hollow fibre membranes under a high hydraulic pressure. Due to the polymeric nature and self-support configuration, a hollow fibre membrane would experience a certain degree of circumferential expansion if there is a high hydraulic pressure applied in its lumen. This expansion would not only stretch the polyamide layer circumferentially but also decrease the membrane thickness and tortuosity. As a result, the area of the membrane inner surface is increased, and the length and resistance for water transport are reduced. Both factors would benefit water transport across the membranes, leading to a higher pure water permeability (i.e. A value). Interestingly, the membranes stabilised at 23 bar had almost comparable salt permeability (i.e. B values) with the membranes stabilised at 15 bar, which means that the stabilisation of hollow fibre membranes at a high hydraulic pressure did not induce any significant defects on the polyamide layer.

Table 9 also summarised the water fluxes and solute rejections tested at 15 bar after the hollow fibre membranes had been stabilised at 23 bar for 1 hour. Similar to the changes in A values, the water fluxes of all membranes increased about 60% after being stabilised at a higher hydraulic pressure. Among them, TFN-(Na-CQDs)-1 still had the highest water flux of 57.95 LMH with a NaCl rejection of 98.6% for brackish water desalination. The solute rejections of all three membranes improved slightly from 97.7% to 98.7, 96.7% to 97.8% and 97.7% to 98.6% for the conventional TFC, TFN-(CQDs)-1 and TFN-(Na-CQDs)-1, respectively. This resulted from the radial compaction of the polyamide layers under a higher stabilisation pressure. Since high-pressure stabilisation could significantly enhance the water flux and slightly improve the solute rejection of hollow fibre membranes, the hollow fibre configuration may be more attractive than flat-sheet membranes to achieve the optimal performance of TFC and TFN membranes for the low-pressure RO process.

### Conclusion

By incorporating NaCQDs into the polyamide layer via interfacial polymerization, the TFN membrane showed a significantly higher water flux than the conventional TFC membrane with a comparable NaCl rejection for brackish water desalination. The performance enhancement arose from the morphological and composition changes of the polyamide layer as a result of NaCQDs incorporation, such as a thinner polyamide layer, a larger effective surface area, more hydrophilic oxygen-containing groups and an enlarged interstitial space among the polyamide chains. In addition, the TFN hollow fibre membrane experienced a certain degree of deformation if there was a high pressure applied on its lumen, resulting in a stretched polyamide layer and a decreased membrane thickness and tortuosity. In other words, the membrane had an expanded inner surface area and a decreased water transport length and resistance after high-pressure stabilisation. By taking advantages of these unique features of hollow fibre configuration, the optimal TFN-(Na-CQDs)-1 hollow fibre membrane had a water flux of 57.95 LMH with a NaCL rejection of 98.6% using a 2000 ppm NaCl aqueous solution as the feed. This separation performance is far superior to the TFN flat sheet membranes incorporated with other carbon-based quantum dots, such as graphene oxide quantum dot (GOQD) and nitrogen-doped graphene oxide quantum dots (N-GOQD).

Whilst the foregoing description has described exemplary embodiments, it will be understood by those skilled in the technology concerned that many variations may be made without departing from the present invention.

1. A thin film composite (TFC) membrane comprising:
a support layer; and
a selective layer on a surface of the support layer, the selective layer formed of a cross-linked polyamide comprising Na⁺-functionalised carbon quantum dots (NaCQD).

2. The TFC membrane according to claim 1, wherein the support layer is a porous hollow fibre support layer.

3. The TFC membrane according to claim 2, wherein the selective layer is on an inner circumferential surface of the hollow fibre support layer.

4. The TFC membrane according to claim 1, wherein the support layer is formed from a polymer or a ceramic material.

5. The TFC membrane according to claim 4, wherein the polymer comprises: polyethersulfone, polysulfone, polyphenylsulfone, polyacrylonitrile, polyimide, polyether imide, polyamide-imide, polyvinylidene fluoride, cellulose acetate, cellulose triacetate, polyetherketone, polyetheretherketone, or a combination thereof.

6. The TFC membrane according to claim 1, wherein the support layer is formed of polyethersulfone.

7. The TFC membrane according to claim 1, wherein the support layer has a thickness of 100-500 μm.

8. The TFC membrane according to claim 1, wherein the selective layer has a thickness of 50-500 nm.

9. The TFC membrane according to claim 1, wherein the TFC membrane has a power density of 15-40 W/m².

10. The TFC membrane according to claim 1, wherein the TFC membrane has a pure water permeability rate of 1.5-6.0 L m⁻² h⁻¹ bar⁻¹.

11. The TFC membrane according to claim 1, wherein the TFC membrane has a burst pressure of at least 15-35 bar.

12. The TFC membrane according to claim 1, wherein the TFC membrane has a salt rejection rate of ≥97%.

13. The TFC membrane according to claim 1, for use in pressure retarded osmosis (PRO), osmotic power generation, or reverse osmosis desalination.

14. A method of forming the TFC membrane according to claim 1, the method comprising:
providing a support layer; and
forming a selective layer on a surface of the support layer through interfacial polymerization, wherein the forming comprises contacting the surface of the support layer with a first solution comprising a polyamine and Na⁺-functionalised carbon quantum dots (NaCQD), removing excess of the first solution by applying air and subsequently contacting the surface of the support layer with a second solution comprising a polyfunctional acyl halide.

15. The method according to claim 14, wherein when the support layer is a porous hollow fibre support layer and the selective layer is on an inner circumferential surface of the hollow fibre support layer, the method comprises:
preparing a module comprising at least one porous hollow fibre support layer potted in the module; and
forming the selective layer on an inner circumferential surface of the hollow fibre support layer through interfacial polymerization.

16. The method according to claim 15, wherein the porous hollow fibre support layer is prepared by:
providing a dope solution comprising a polymer solution or a ceramic solution, a solvent/non-solvent mixture and water to an annulus of a spinneret;
providing a bore solution to an inner tube of the spinneret; and
extruding the dope solution and bore solution through the spinneret into a coagulation bath, thereby obtaining a porous hollow fibre support layer.

17. (canceled)

18. The method according to claim 14, wherein the first solution comprises a polyamine selected from: m-phenylenediamine (MPD), p-phenylenediamine, p-xylylenediamine, cyclohexanediamine, piperazine, branched or dendrimeric polyethylenimine, or a combination thereof.

19. The method according to claim 14, wherein the first solution further comprises a surfactant.

20. (canceled)

21. (canceled)

22. The method according to claim 14, wherein the second solution comprises a polyfunctional acyl halide selected from: trimesoyl chloride (TMC), isophthaloyl chloride, terephthaloyl chloride, 1,3,5-cyclohexane tricarbonyl chloride, 1,2,3,4-cyclohexane tetracarbonyl chloride, or a combination thereof.

23. The method according to claim 14, wherein the second solution further comprises an organic solvent.

24. (canceled)
